(19) United States
(12) Patent Application Publication
(10) Pub. No.: US 2026/0233409 A1
(43) Pub. Date: Aug. 13, 2026

(54) Interactive Pet Training Robot

(71) Applicant: Mary McDonald, Pflugerville, TX (US)

(72) Inventor: Mary McDonald, Pflugerville, TX (US)

(73) Assignee: Mary Alvarado McDonald, Pflugerville, TX (US)

(21) Appl. No.: 19/050,505

(22) Filed: Feb. 11, 2025

(51) Int. Cl. B25J 11/00; A01K 15/02; B25J 5/00; B25J 9/16; B25J 13/08

(52) U.S. Cl. CPC B25J 11/008; A01K 15/02; B25J 5/007; B25J 9/1666; B25J 9/1697; B25J 13/086

(57) ABSTRACT

This invention is a pet training robot engineered to observe and modify animal behavior through interactive, real-time engagement. Featuring sophisticated sensors and customizable training protocols, the device increases the effectiveness of pet training by delivering consistent and adaptive reinforcement. This invention will revolutionize pet training by combining advanced technology with the familiar touch of an owner's voice, and positive reinforcement with immediate dispensation of treats, offering a reliable, effective, and convenient solution to modern pet training challenges.

### II. BACKGROUND OF INVENTION

Pet training has long been an essential practice for promoting desirable behavior, strengthening the bond between pets and their owners, and ensuring safety in the home and public spaces. Traditional pet training methods often rely on human involvement to give commands, monitor behavior, and reinforce proper actions.
A) Challenges for modern pet owners
   1) Dependence on Human Presence:
      a) Traditional pet training methods require the pet owner or a trainer to be physically present during the training sessions. However, this can be impractical for individuals with busy schedules, travel commitments, or extended work hours.
      b) The lack of consistent reinforcement, particularly when the owner is absent, often hinders the long-term retention of learned behaviors.
   2) Consistency and Timing:
      a) Effective training depends on immediate feedback, both to reward correct behavior and discourage undesirable actions. Delays in reinforcing commands can confuse pets and slow progress.
      b) Many pet owners struggle to provide consistent training cues, which can lead to mixed signals and erratic behavior from their pets.
   3) Limited Adaptability of Existing Devices:
      a) While some automated pet training devices are available in the market, they typically operate on preprogrammed routines that do not adapt to the unique behaviors or learning pace of individual pets.
      b) These devices often lack advanced features such as voice-based personalization or real-time monitoring, reducing their effectiveness in addressing specific training needs.
   4) Separation Anxiety and Behavioral Issues:
      a) Pets often experience anxiety or behavioral regression when left alone for extended periods. Without reinforcement of training commands during the owner's absence, undesirable behaviors such as excessive barking, destructive chewing, or house soiling may develop.
      b) Owners may attempt to mitigate these issues with crate training or behavioral tools, but these methods alone may not address the root cause of anxiety or ensure ongoing training progress.
B) Limitations of Existing Solutions: Current automated pet training devices, while helpful in certain scenarios, have notable shortcomings that limit their effectiveness:
   1) Lack of Personalization: Most devices do not incorporate the pet owner's voice, a crucial factor for pets who associate their owner's commands with training. This can result in less effective behavior reinforcement.
   2) Inability to Adapt: Automated devices often lack adaptability to changing circumstances or the specific behavioral traits of the pet. For instance, they may continue to deliver preprogrammed commands without considering whether the pet is progressing or struggling.
   3) Minimal Real-Time Feedback: Existing devices rarely offer real-time monitoring or feedback mechanisms to adjust training in response to the pet's actions, leaving gaps in the training process.
   4) Lack of reward system: Current solutions do not have automated reward delivery systems to reinforce desired behaviors.
C) Addressing the Challenges with the Pet Training Robot: The invention of a pet training robot addresses these limitations through advanced features tailored to modern pet owners' needs:
   1) Voice-Based Reinforcement: The robot uses recordings of the pet owner's voice to deliver training commands, maintaining consistency in cues and strengthening the pet's association with the owner's presence, even when they are away.
   2) Immediate Food-Based Reward System: The robot dispenses a treat to the pet when the video system detects compliance with a command, reinforcing desired behaviors.
   3) Adaptive Training Programs: Equipped with sensors and AI algorithms, the robot can monitor the pet's behavior in real-time, adjusting its training program to match the pet's progress and learning speed.
   4) Continuous Interaction: Unlike static devices, the robot offers mobility and interactive elements to engage the pet actively, reinforcing commands through movement, sounds, and treat rewards.
   5) Convenience for Owners: By providing consistent training and feedback in the owner's absence, the robot alleviates the burden on busy pet owners, ensuring their pets continue to learn and retain desirable behaviors.

This innovative solution bridges the gap between traditional training methods and modern technological advancements, offering an effective, personalized, and adaptive approach to pet training.

### III. SUMMARY OF INVENTION

The present invention introduces an automated pet training robot designed to address the challenges of traditional and existing automated pet training methods.
A) Advanced features that provide real-time behavior monitoring, personalized training programs, and continuous interaction, making it a revolutionary solution for pet training.
   1) Real-Time Behavior Monitoring: The robot is equipped with sensors and cameras to observe pet behavior continuously. This allows it to detect and respond to specific actions, providing immediate reinforcement for desired behaviors and corrective measures for undesired ones.
   2) Voice-Based Reinforcement: Utilizing recordings of the pet owner's voice, the robot delivers training commands that maintain the familiarity and consistency crucial for effective learning. This feature strengthens the bond between the pet and owner, even in the owner's absence.
   3) Food Based Reward System: The robot will dispense a treat for the pet when the video system detects compliance with a command in order to reinforce desired behaviors. This provides immediate rewards that the pet will associate with desired behaviors.
   4) Customizable and Adaptive Training Programs: The robot uses AI algorithms to tailor its training routines to the unique needs and progress of each pet. It adjusts commands, rewards, and reinforcement strategies dynamically, ensuring that training remains effective and personalized.
   5) Interactive Capabilities: The robot actively engages pets with mobility, sounds, and treat dispensing to maintain their interest and reinforce positive behavior. These interactive elements mimic the presence of a trainer, offering a more engaging training experience.
   6) Convenience for Pet Owners: By automating the training process, the robot reduces the time and effort required by pet owners. It ensures consistency in training, even during the owner's busy schedule or extended absence, providing peace of mind.
B) High-Level Overview of Problem Resolution: The pet training robot directly addresses the limitations of traditional and automated training methods:
   1) Addresses Busy Schedules: The robot allows pet owners to maintain consistent training without being physically present, reducing the reliance on human involvement.
   2) Improves Training Consistency: Immediate feedback with treats, clicking and the use of the owner's voice provide clarity and consistency in commands, which are crucial for effective learning.
   3) Adapts to Individual Pet Needs: Unlike static devices, the robot's adaptive programming ensures that each pet receives a tailored training experience, regardless of their behavior or learning pace.
   4) Reduces Separation Anxiety: By interacting with the pet and reinforcing commands, the robot helps mitigate anxiety and boredom during the owner's absence, promoting positive behavior.

In summary, this invention revolutionizes pet training by combining advanced technology with the familiar touch of an owner's voice, and positive reinforcement with immediate dispensation of treats, offering a reliable, effective, and convenient solution to modern pet training challenges.

### IV. BRIEF DESCRIPTION OF DRAWINGS

FIG. 1: Perspective view of the pet training robot.

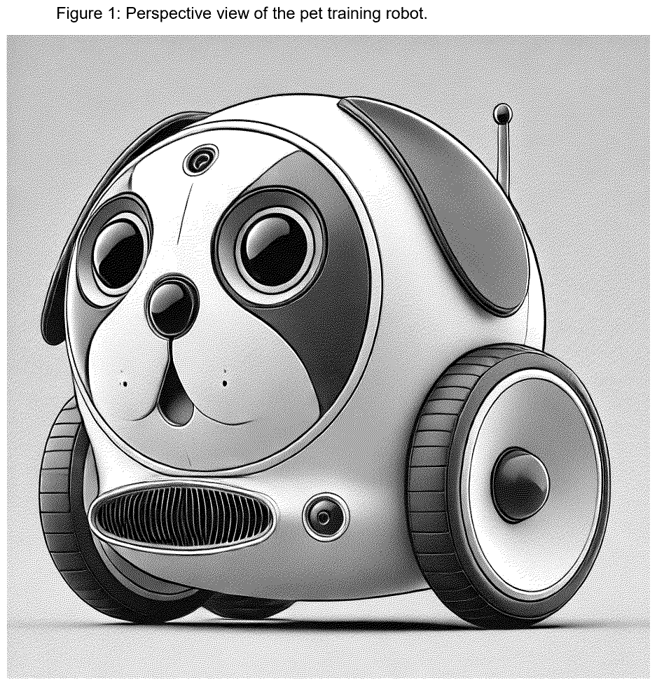

### V. DETAILED DESCRIPTION OF INVENTION

A) Overall Structure: The pet training robot is designed to be compact, mobile, and interactive, ensuring both functionality and pet engagement. Below are its main physical components:
   1) Housing:
   The robot's body features a durable, pet-safe, and lightweight housing made from ABS plastic with smooth edges to prevent injury. The design includes a round, approachable shape, resembling a playful animal, which encourages interaction with pets.
   2) Mobility System: Equipped with two large, rubber-coated wheels for traction and stability, and a caster wheel for support, the robot can move smoothly on a variety of surfaces, including carpets, hardwood floors, and tiles. Each wheel is powered by a brushless DC motor controlled by an onboard motor driver.
   3) Sensors: The robot includes the following sensors:
      a) Proximity Sensors: Detect obstacles and navigate around them.
      b) Microphone Array: Recognizes vocal commands and detects ambient sounds.
      c) Camera: Provides real-time video monitoring of the pet and identifies behaviors such as sitting, standing, or barking.
      d) Temperature and Humidity Sensors: Ensure the device operates within safe environmental conditions.
   4) Interactive Elements:
      a) Speakers: Deliver commands in the pet owner's voice or play calming sounds.
      b) Treat Dispenser: Dispenses small treats as a reward for desirable behavior.
      c) LED Lights: Provide visual cues, such as glowing green for rewards or red for warnings.
   5) Power Supply: A rechargeable lithium-ion battery powers the robot, providing up to 8 hours of continuous operation. The battery is housed internally and can be charged via a USB-C port.
B) Control System: The control system integrates hardware and software components for seamless operation:
   1) Hardware:
      a) Microcontroller: Manages low-level functions such as motor control and sensor data processing.
      b) AI Processor: A compact processor (e.g., NVIDIA Jetson Nano or equivalent) runs the machine learning models for real-time decision-making.
      c) Wireless Connectivity: Includes Wi-Fi and Bluetooth modules for communication with the owner's smartphone or cloud-based systems.
   2) Software:
      a) Behavior Recognition Algorithm: Uses image and sound processing to identify pet actions, such as barking, sitting, or jumping.
      b) Decision-Making Logic: Based on pre-programmed training protocols, the robot determines whether to reward, correct, or ignore specific behaviors.
      c) Navigation System: Implements obstacle avoidance and pathfinding algorithms to ensure smooth movement within a designated area.
C) Training Programs: The robot offers a variety of training routines, customizable to suit individual pets and their specific needs:
   1) Command Training: Reinforces basic commands like “sit,” “stay,” and “come” using voice cues and treat rewards.
   2) Behavior Correction: Discourages undesirable behaviors (e.g., barking or chewing) by delivering a verbal warning or activating a distracting sound.
   3) Engagement Programs: Keeps pets mentally and physically active by initiating play routines, such as chasing the robot or solving treat puzzles.
   4) Custom Routines: Owners can program specific commands and responses using a mobile app, enabling tailored training programs.
   5) Methods for Reinforcement:
      a) Positive reinforcement is primarily used, with treat dispensing, verbal praise, or play sounds when a command is successfully followed.
      b) In cases of undesirable behavior, the robot employs gentle corrective measures, such as emitting a low beep or redirecting the pet's attention to a toy.
D) User Interface: The robot provides an intuitive interface for pet owners to interact with and manage its operations:
   1) Mobile Application:
      a) Features: The app allows users to set training goals, monitor the pet in real-time through the robot's camera, and track progress with analytics.
      b) Customization: Owners can upload voice recordings, adjust training difficulty, and set operating schedules.
      c) Notifications: Sends alerts for completed training sessions, low battery, or unusual pet behavior.
   2) Onboard Controls: The robot includes simple physical buttons for basic commands like starting/stopping training sessions or activating manual treat dispensing.
   3) Voice Control: Pet owners can give live commands through the app or directly to the robot via its microphone array.
E) Variations and Enhancements: The robot design allows for several variations and future upgrades:
   1) Advanced Sensors: Integration of more sophisticated sensors like LIDAR for improved navigation or thermal imaging to monitor pet health.
   2) Expanded Treat Compatibility: An adjustable treat dispenser accommodating a wider range of treat sizes and types.
   3) Robust AI Training Models: Over-the-air software updates to enhance behavior recognition and adaptability.
   4) Interactive Accessories: Compatibility with external toys or accessories that the robot can control for added engagement.

A) Broad claims
1) An automated pet training robot—a self-contained robotic device designed to monitor, interact with, and train pets without requiring the physical presence of the pet owner.
2) A mobility system configured to navigate a predefined area—a system that enables the robot to move autonomously, avoid obstacles, and maintain proximity to the pet within a designated training area.
3) A sensor array configured to detect pet behavior—a combination of cameras, microphones, and other sensors to monitor pet activities, recognize specific behaviors, and respond accordingly.
4) A control unit configured to process sensor data and execute training protocols—an integrated microcontroller and AI processor that analyzes input from the sensor array, makes decisions based on predefined training programs, and initiates appropriate responses.
5) An interaction module configured to deliver stimuli to reinforce desired behavior—a set of tools, including a treat dispenser, speakers for verbal commands, and LED lights, to provide positive reinforcement for training compliance.

B) Intermediate claims
1) An automated treat dispenser for rewarding training compliance—a mechanism capable of dispensing treats in measured amounts in response to the detection of desired pet behaviors.
2) A video system to monitor pet behavior and adjust training protocols—a high-definition camera system integrated with AI to provide real-time monitoring and adaptive adjustments to training routines based on observed pet behavior.
3) A voice-based command system—a feature that allows the robot to deliver commands and praise using pre-recorded messages in the pet owner's voice, ensuring consistency and familiarity.
4) Adaptive training programs configured for individual pets-algorithms that dynamically adjust training routines based on a pet's progress, temperament, and specific needs, enhancing effectiveness over time.
5) A navigation and obstacle avoidance system—a set of proximity sensors and path-finding algorithms that enable the robot to operate safely and efficiently in a home environment.

C) Specific claims
1) A customizable mobile application for remote interaction—a smartphone application that enables pet owners to monitor the robot's operations, customize training routines, and track progress remotely.
2) A multi-mode reward system—a combination of rewards, including treats, verbal praise, and interactive play, to maintain engagement and encourage compliance.
3) Behavioral correction protocols—features designed to discourage undesirable pet behaviors through non-invasive measures such as audio warnings or distraction techniques.
4) Integration with external accessories—compatibility with external pet accessories, such as toys or training tools, which can be controlled or monitored by the robot.
5) A rechargeable power system with extended battery life—a power system that allows prolonged operation with features for low-battery notifications and easy charging.
6) Environmental monitoring sensors—sensors to detect environmental conditions such as temperature and humidity, ensuring safe operation for both the robot and the pet.
